(19) United States
(12) Patent Application Publication
(10) Pub. No.: US 2026/0163891 A1
(43) Pub. Date: Jun. 11, 2026

(54) DEVICE ATTESTATION OVER LTPI INTERFACE USING PRIVILEGED MODE SYSTEMS AND METHODS

(71) Applicant: Lattice Semiconductor Corporation, Hillsboro, OR (US)

(72) Inventors: Satheesh Chellappan, El Dorado Hills, CA (US); Munir Ahmad, Leander, TX (US)

(21) Appl. No.: 19/296,884

(22) Filed: Aug. 11, 2025

Related U.S. Application Data
(60) Provisional application No. 63/682,743, filed on Aug. 13, 2024.

(51) Int. Cl. H04L 9/40

(52) U.S. Cl. CPC H04L 63/126; H04L 63/0428

(57) ABSTRACT

A system, method, and computer program product for performing attestation by a baseboard management controller (BMC) of target devices are provided. A data center secure control module (DC-SCM) coupled to BMC includes a PLD with an arbiter that communicates using LTPI IP over I2C with the HPM. The BMC issues MCPT requests for attestation information to target devices. The arbiter at the DC-SCM establishes a two-way communication mode over the LTPI IP with the HPM to transfer the requests to the HPM on a primary LTPI I2C channel. A PLD with an arbiter at HPM routes the requests to target devices using virtual I2C nodes. The target devices issue responses with the attestation information. The responses are routed to the arbiter of the HPM, that uses the virtual I2C nodes to route the responses over a secondary LTPI I2C channel to the DC-SCM. The DC-SCM routes the responses to the BMC.

### CROSS-REFERENCE TO RELATED APPLICATION

This application claims the benefit of and priority to U.S. Provisional Patent Application No. 63/682,743 filed August 13, 2024 and entitled “DEVICE ATTESTATION OVER LTPI INTERFACE USING PRIVILEGED MODE SYSTEMS AND METHODS,” which is incorporated herein by reference in its entirety.

### TECHNICAL FIELD

The disclosure generally relates to device attestation, and more specifically to device attestation over LTPI IP.

### BACKGROUND

Data centers, hyper-scaler servers, and original equipment manufacturer servers attest various platform devices, particularly during boot-up. However, communication interfaces, such as LTPI IP, I2C, or I3C do not define an attestation standard. A conventional, decentralized and expensive solution is a custom attestation, specific to each platform device. This conventional solution requires additional pins and wires between the data center secure control module (DC-SCM) and the host processing module (HPM) that is coupled to the platform devices. As the number of different platform devices that require attestation increases, the conventional solution becomes unworkable due to a sheer number of additional pins and wires that would be required to connect the different platform devices to communicate between the DC-SCM and HPM.

### BRIEF DESCRIPTION OF THE DRAWINGS

FIG. 1 illustrates a block diagram of a programmable logic device (PLD) in accordance with an embodiment.

FIG. 2 illustrates a block diagram of an example architecture for establishing a communication interface for device attestation between a baseboard management controller (BMC) and a host processing module (HPM), according to some embodiments.

FIG. 3 is a diagram of an example attestation mechanism, according to some embodiments.

FIG. 4 is a block diagram of another architecture that illustrates a communication interface for device attestation between a BMC and an HPM, according to some embodiments.

FIG. 5 is a block diagram of another architecture that illustrates a communication interface for device attestation between a requester and target devices, according to some embodiments.

FIG. 6 is a diagram of a software stack for implementing a Secure Platform Data Model (SPDM) over an I2C, according to some embodiments.

FIG. 7 is a flowchart of an exemplary method of an attestation mechanism, according to some embodiments.

Embodiments of the present disclosure and their advantages are best understood by referring to the detailed description that follows. It should be appreciated that like reference numerals are used to identify like elements illustrated in one or more of the figures.

### DETAILED DESCRIPTION

The embodiments are directed to an architecture that uses a Low-Voltage Differential Signaling (LVDS) tunneling protocol interface (LTPI), collectively referred to as LTPI IP and a Management Control Transfer Protocol (MCTP) to attest multiple devices to a baseboard management controller (BMC) that is external to a host processing module (HPM). Such attestation mechanism allows BMC to verify multiple devices without increasing a number of pins between a data center secure control module (DC-SCM) that connects BMC to the HPM.

In some embodiments, the attestation mechanism may occur at BMC boot or start-up. In particular, the BMC may enter a boot or a startup mode and communicate the mode to a programmable logic device (PLD) of a data center secure control module (DC-SCM). An arbiter in the PLD may switch the mode of operation of the PLD from a one-way communication mode over the LTPI to a privileged or a two-way communication mode over the LTPI. In the two-way communication mode, because LTPI is a one directional interface while MCTP uses two directions to attest various device, the arbiter uses an I2C interface and defines a primary LTPI I2C channel for egress communications and a secondary LTPI I2C channel for ingress communications. The DC-SCM may then transmit the discovery requests from the BMC as MCTP packets over the primary LTPI I2C channel to the HPM. The PLD of the HPM may receive the discovery requests over the LTPI I2C, use an arbiter at the HPM to assign virtual I2C nodes to the target devices, and transmit the discovery requests to the multiple target devices. The target devices may transmit verification responses as MCTP packets with the attestation information back to the HPM. The arbiter may use the virtual I2C nodes to direct the verification responses to DC-SCM using the secondary LTPI I2C channel, which may then pass the verification responses to BMC for verification. Once the BMC completes the attestation mechanism in the boot mode, the arbiter may switch back to the one-way communication mode.

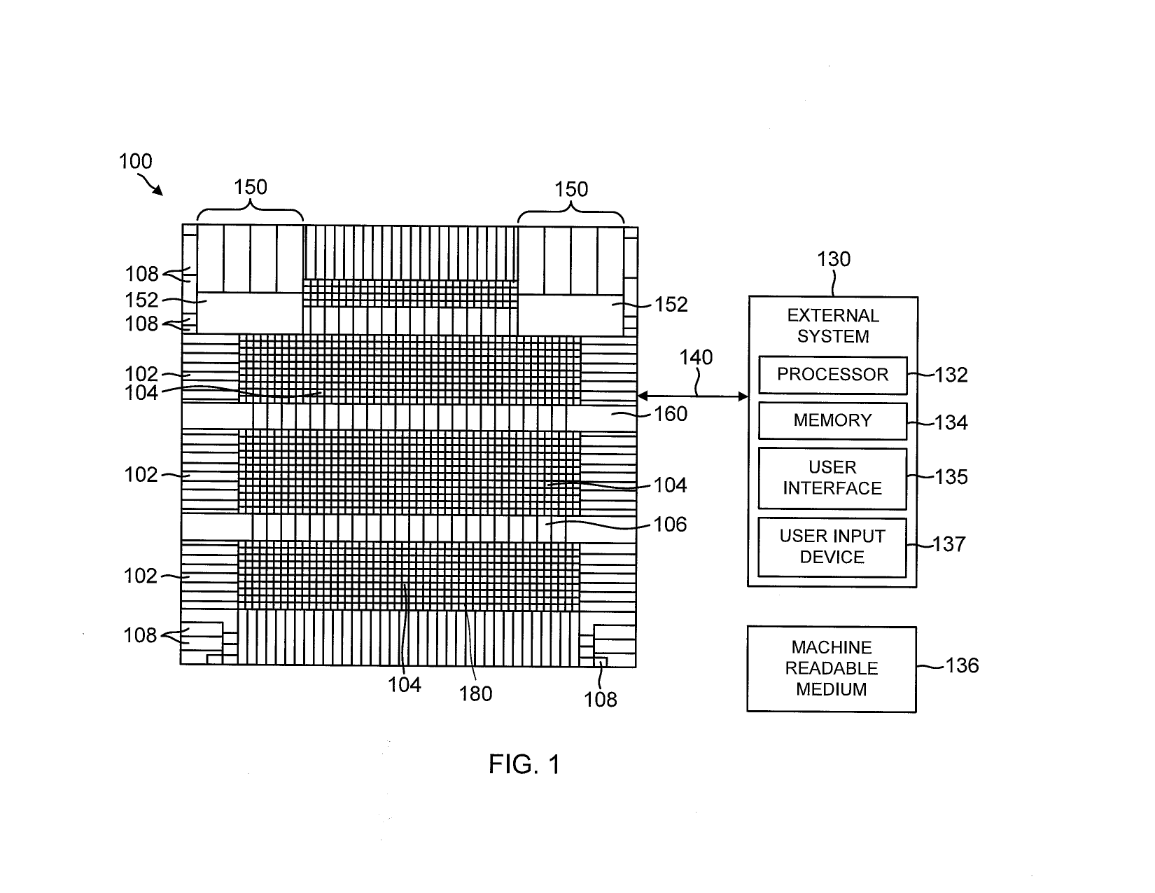

FIG. 1 illustrates a block diagram of a programmable logic device (PLD) 100 in accordance with an embodiment of the disclosure. PLD 100 (e.g., a field programmable gate array (FPGA)), a complex programmable logic device (CPLD), a field programmable system on a chip (FPSC), or other type of programmable device) generally includes input/output (I/O) blocks 102 and logic blocks 104 (e.g., also referred to as programmable logic blocks (PLBs), programmable functional units (PFUs), or programmable logic cells (PLCs)).

I/O blocks 102 provide I/O functionality (e.g., to support one or more I/O and/or memory interface standards) for PLD 100, while programmable logic blocks 104 provide logic functionality (e.g., LUT-based logic or logic gate array-based logic) for PLD 100. Additional I/O functionality may be provided by serializer/ deserializer (SerDes) blocks 150 and physical coding sublayer (PCS) blocks 152. PLD 100 may also include hard intellectual property core (IP) blocks 160 to provide additional functionality (e.g., substantially predetermined functionality provided in hardware which may be configured with less programming than logic blocks 104).

PLD 100 may also include blocks of memory 106 (e.g., blocks of EEPROM, block SRAM, and/or flash memory), clock-related circuitry 108 (e.g., clock sources, PLL circuits, and/or DLL circuits), and/or various routing resources 180 (e.g., interconnect and appropriate switching logic to provide paths for routing signals throughout PLD 100, such as for clock signals, data signals, or others) as appropriate. In general, the various elements of PLD 100 may be used to perform their intended functions for desired applications, as would be understood by one skilled in the art.

For example, certain I/O blocks 102 may be used for programming memory 106 or transferring information (e.g., various types of user data and/or control signals) to/from PLD 100. Other I/O blocks 102 include a first programming port (which may represent a central processing unit (CPU) port, a peripheral data port, an SPI interface, and/or a sysCONFIG programming port) and/or a second programming port such as a joint test action group (JTAG) port (e.g., by employing standards such as Institute of Electrical and Electronics Engineers (IEEE) 1149.1 or 1532 standards). In various embodiments, I/O blocks 102 may be included to receive configuration data and commands (e.g., over one or more connections 140) to configure PLD 100 for its intended use and to support serial or parallel device configuration and information transfer with SerDes blocks 150, PCS blocks 152, hard IP blocks 160, and/or logic blocks 104 as appropriate.

It should be understood that the number and placement of the various elements are not limiting and may depend upon the desired application. For example, various elements may not be required for a desired application or design specification (e.g., for the type of programmable device selected).

Furthermore, it should be understood that the elements are illustrated in block form for clarity and that various elements would typically be distributed throughout PLD 100, such as in and between logic blocks 104, hard IP blocks 160, and routing resources 180 to perform their conventional functions (e.g., storing configuration data that configures PLD 100 or providing interconnect structure within PLD 100). It should also be understood that the various embodiments disclosed herein are not limited to programmable logic devices, such as PLD 100, and may be applied to various other types of programmable devices, as would be understood by one skilled in the art.

An external system 130 may be used to create a desired user configuration or design of PLD 100 and generate corresponding configuration data to program (e.g., configure) PLD 100. For example, system 130 may provide such configuration data to one or more I/O blocks 102, SerDes blocks 150, and/or other portions of PLD 100. As a result, programmable logic blocks 104, various routing resources, and any other appropriate components of PLD 100 may be configured to operate in accordance with user-specified applications.

In the illustrated embodiment, system 130 is implemented as a computer system. In this regard, system 130 includes, for example, one or more processors 132 which may be configured to execute instructions, such as software instructions, provided in one or more memories 134 and/or stored in non-transitory form in one or more non-transitory machine readable mediums 136 (e.g., which may be internal or external to system 130). For example, in some embodiments, system 130 may run PLD configuration software, such as Lattice Diamond System Planner software available from Lattice Semiconductor Corporation to permit a user to create a desired configuration and generate corresponding configuration data to program PLD 100.

System 130 also includes, for example, a user interface 135 (e.g., a screen or display) to display information to a user, and one or more user input devices 137 (e.g., a keyboard, mouse, trackball, touchscreen, and/or other device) to receive user commands or design entry to prepare a desired configuration of PLD 100.

PLD 100 may facilitate an attestation mechanism that attests various platform devices. PLD 100 may be incorporated into a data center secure control module (DC-SCM), a host processing module (HPM), or into another device, and may facilitate device attestation over LTPI. Specifically, a BMC may use PLDs 100 incorporated into DC-SCM and/or HPM to verify multiple platform devices that may be connected to DC-SCM and/or HPM.

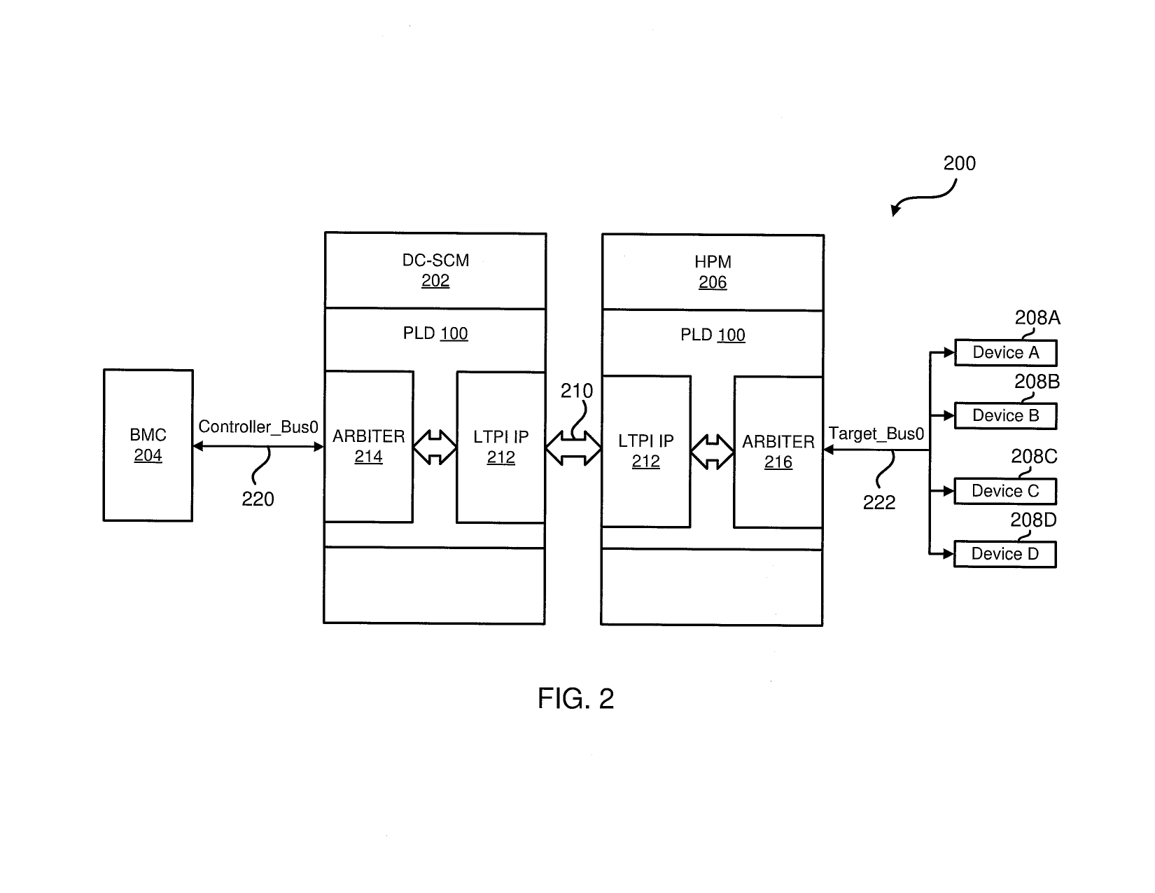

FIG. 2 illustrates a block diagram 200 of an example architecture for establishing a communication interface for device attestation between a baseboard management controller (BMC) and a host processing module (HPM), according to some embodiments. The architecture includes a data center secure control module (DC-SCM) 202, a BMC 204, an HPM 206, and multiple target devices 208A-D. DC-SCM 202 may be a hardware component that handles security functions for HPM 206 and target devices 208A-D that are coupled to HPM 206 or to DC-SCM 202 (not shown).

HPM 206 may be a computer, a network server, a storage device, or another hardware device in a data center. HPM 206 may host or be coupled to various target devices 208A-D of a server in a data center. Target devices 208A-D may be hardware devices, such as various control processing units (CPUs), graphics processing units (GPUs), network interface cards (NICs), various memories and storage devices, power supplies, cooling fans, etc. For simplicity, four target devices 208A-D are shown in FIG. 2, though the implementation is not limited to this embodiment, and there may be tens of target devices 208A-D that maybe hosted or coupled to HPM 206.

PLD 100 may be incorporated into DC-SCM 202 and HPM 206. DC-SCM 202 and HPM 206 may use PLDs 100 to communicate via an I/O interface 210. I/O interface 210 may include multiple channels that are serialized using a Low-Voltage Differential Signaling (LVDS) tunneling protocol interface (TIP) or LTPI IP. The serialized channels may be GPIO, I2C, UART, OEM, and data interfaces, in some embodiments.

BMC 204 is a specialized processor that is separate from HPM 206 and that remotely monitors and manages a host system, such as HPM 206. BMC 204 may also gather and obtain device information of target devices 208A-D. Example information may include device monitoring, sensor monitoring, remote firmware updates, system event logging, error reporting, and the like. In some instances, BMC 204 executes an operating system (OS), which may be a Linux OS. BMC 204 may communicate with target devices 208A-D via PLDs 100 in DC-SCM 202 and HPM 206.

In some embodiments, prior to obtaining information from target devices 208A-D, BMC 204 may verify target devices 208A-D using an attestation mechanism. The attestation mechanism may be a process during which a new component in the system, e.g., one or more of target devices 208A-D, may provide attestation information, such as a certificate, to BMC 204 that the target device is a trusted or authentic device.

The embodiments are directed to an attestation mechanism that uses a Management Component Transfer Protocol (MCTP) over LTPI to perform attestation of target devices 208A-D. This attestation mechanism may replace a conventional, decentralized, and expensive approach that requires target devices 208A-D to connect to BMC 204 using a limited number of pins at DC-SCI 202, a technique that is unscalable as the number of target devices 208A-D that should be verified continues to grow. Further, the embodiments discussed herein, are unlikely to increase additional workload over LTPI IP because attestation typically occurs during a system boot up when the LTPI bus is typically idle.

As discussed above, DC-SCM 202 and HPM 206 may communicate over I/O interface 210 using LTPI IP 212. LTPI IP 212 may support a predefined number of I2C channels, such as 24 number of I2C channels. The attestation mechanism may be performed using the existing I2C channels. In this way, performing attestation of target devices 208A-D over I/O interface 210 that uses LTPI IP 212 does not increase a number of pins. Although the embodiments will be described with reference to I2C channels, the embodiments are also applicable toI3C channels.

The attestation mechanism uses two communication directions to perform attestation between BMC 204 and target devices 208A-D. In particular, when BMC 204 uses MCTP to perform attestation, MCTP uses two-way communication between BMC 204 and target devices 208A-D. However, LTPI IP 212 is a one directional protocol. Accordingy, to facilitate two-way communication using LTPI IP 212, PLD 100 of DC-SCM 202 may include an arbiter 214 and PLD 100 of HPM 206 may include an arbiter 216. Arbiters 214, 216 may define operation modes for LTPI IP 212 and switch between the modes. For example, arbiters 214, 216 may define a one-way communication mode of operation and a two-way communication mode of operation. The one-way communication mode may be a conventional one-way communication using LTPI IP 212. A two-way communication mode of operation that may be a two-way communication using LTPI IP 212. The two-way communication mode of operation may be used to perform the attestation mechanism and may be used when BMC 204 is booting up or at another time when the attestation mechanism may take place.

To define a two-way communication mode, arbiters 214, 216 may select two LTPI I2C channels and configure one LTPI I2C channel as a primary channel and the other LTPI I2C channel as a secondary channel. The primary channel may handle egress communications from PLD 100 and the secondary channel may handle ingress communications to PLD 100. During the attestation mechanism, arbiter 214 may configure an LTPI I2C channel from DC-SCM 202 to HPM 206 as a primary channel, and an LTPI I2C channel from HPM 206 to DC-SCM 202 as a secondary channel. Alternatively, in a scenario where HPM 206 initiates an attestation mechanism, HPM 206 may configure LTPI I2C channel from HPM 206 and to DC-SCM 202 as a primary channel, and LTPI I2C channel to HPM 206 and from DC-SCM 202 as a secondary channel.

In some embodiments, suppose BMC 204 initiates an attestation mechanism. BMC 204 may communicate with DC-SCM 202 over a communication interface 220. Communication interface 220 may be a bus that transmits MCTP packets. Further, messages formatted using a Secure Platform Data Model (SPDM) (or another model) that includes an attestation mechanism may be encapsulated within the body of the MCTP packets. The SPDM may define messages, data objects, and sequences for performing message exchanges using a variety of transport and physical medium, including MCTP. The SPDM enables access to low-level security capabilities and operations by specifying a managed level for device authentication, firmware measurement, and certificate management attestation requests. In this way, BMC 204 may use the communication interface 220 to send an attestation command using SPDM encapsulated in MCTP packets to arbiter 214. The attestation command may cause arbiter 214 to switch to a two-way mode of operation, and configure an egress LTPI I2C channel between DC-SCM 202 to HPM 206 as a primary channel, and an ingress LTPI I2C channel between DC-SCM 202 and HPM 206 as a secondary channel. In this way, communications from BMC 204 and target devices 208A-D may be communicated using a primary LTPI I2C channel, and communications from target devices 208A-D to BMC 204 may be communicated using a secondary channel. Once the two-way communication is established, BMC 204 may perform an attestation mechanism using MCTP and SPDM, or MCTP and another protocol over LTPI IP 212.

In some embodiments, arbiter 216 may communicate with target devices 208A-D over communication interface 222. Communication interface 222 may be an I2C bus between HPM 206 and target devices 208A-D. Arbiter 216 may define multiple virtual I2C nodes for each LTPI I2C channel. Each of the virtual I2C nodes may be assigned to a corresponding target device in target devices 208A-D. In this way, multiple target devices 208A-D may communicate with arbiter 216 using the same communication interface 222 and then use the same LTPI I2C channel to transmit attestation information to DC-SCM 202.

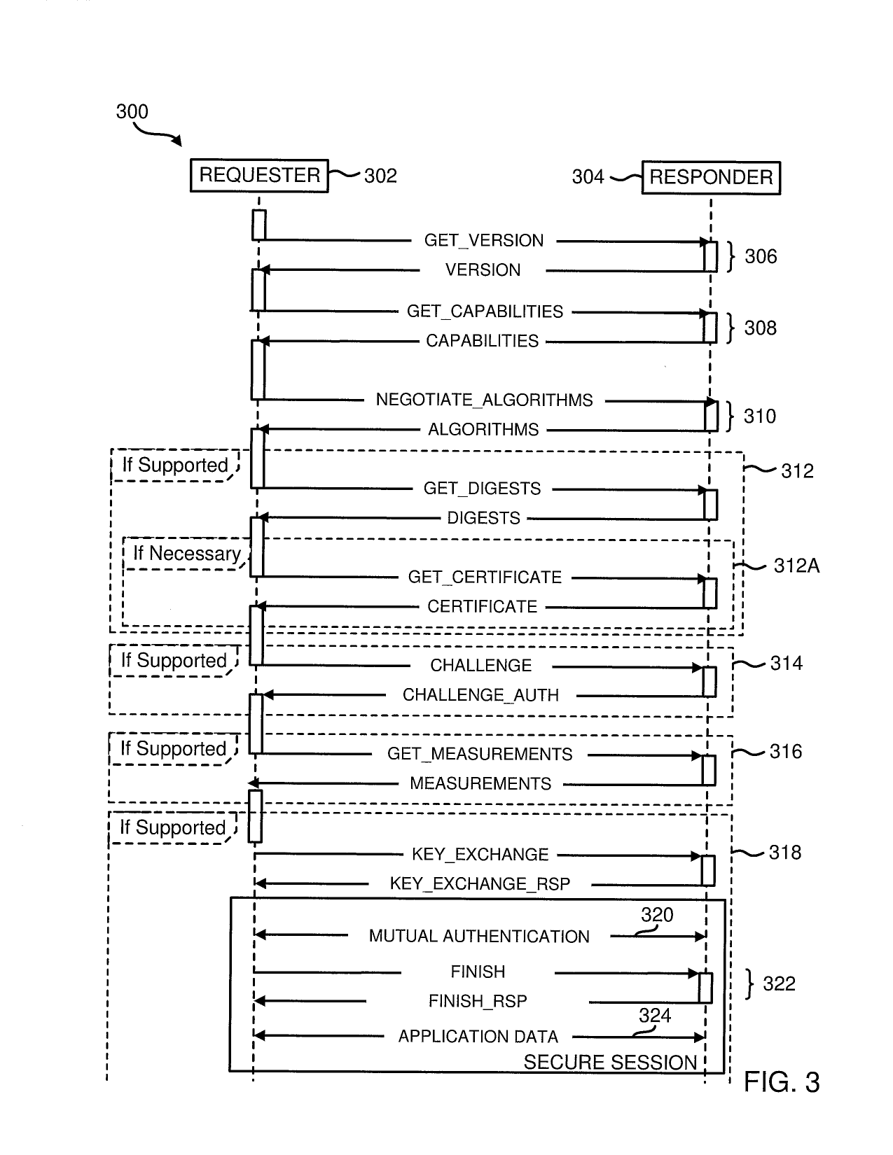

FIG. 3 is a diagram 300 of an example attestation mechanism, according to some embodiments. The illustrated attestation mechanism uses SPDM, but other attestation mechanisms may also be used. In some instances, BMC 204 may be a requester 302 that requests attestation information and target devices 208A-D may be responders 304. As discussed above, attestation mechanism may occur when BMC 204 is booted up, and may cause arbiter 214 and/or arbiter 216 to change to a two-way communication mode of operation.

At operation 306, requester 302 may request and receive a version of hardware or software executed by responder 304.

At operation 308, requester 302 may request and receive capabilities of responder 304.

At operation 310, requester 302 and responder 304 may negotiate one or more algorithms that may be used to communicate messages.

At an optional operation 312, requester 302 may request and receive digests from responder 304. As part of operation 312, e.g., at operation 312A, requester 302 may also request and receive a certificate from responder 304.

At an optional operation 314, requester 302 may authenticate responder 304 using a challenge. For example, requester 302 may communicate request with a challenge from responder 304. Responder 304 may then respond with an answer to a challenge and communicate the answer to requester 302.

At an optional operation 316, requester 302 may request and receive measurements from responder 304. Measurements may include temperature, speed, etc., of responder 304.

At an optional operation 318, requester 302 may exchange keys with responder 304. The keys may facilitate data encryption and facilitate requester 302 and responder 304 exchanging encrypted application data.

At operation 320, attestation may be performed. For example, requester 302 may issue an attestation request to responder 304 to verify responder 304. The request may be made over a primary LTPI I2C channel, and then arbiter 216 may transmit the request to a virtual I2C node associated with responder 304. In response, responder 304 may generate a verification response with the attestation information and use a virtual I2C node to route the verification response to the secondary LTPI I2C channel via arbiter 216.

At operation 322, requester 302 may generate a request indicating that the attestation mechanism is complete, and receive a response indicating same from responder 304.

Once attestation mechanism is complete, arbiters 214 and/or 216 may switch to a one-way mode of operation, and requester 302 and responder 304 may communicate application data to each other over LTPI IP.

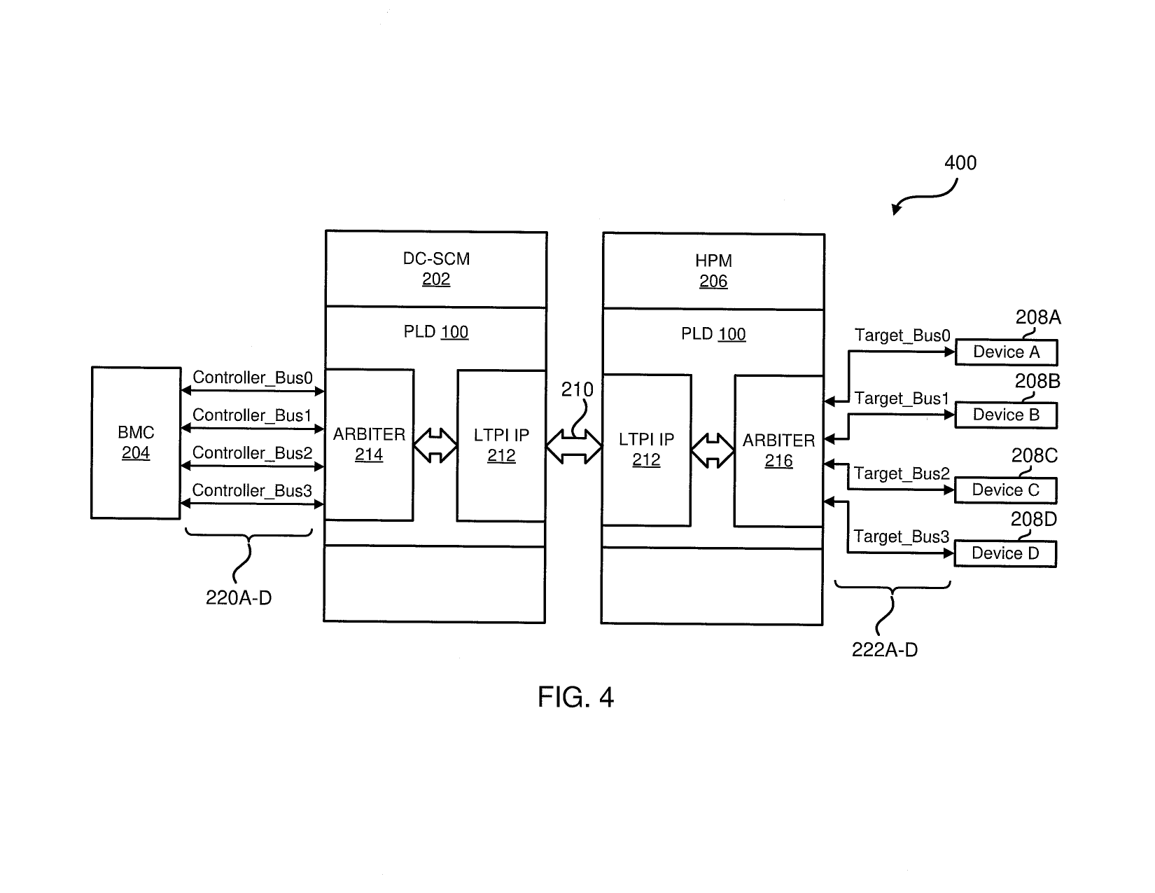

FIG. 4 is a block diagram 400 of another architecture that illustrates a communication interface for device attestation between a BMC and an HPM, according to some embodiments. The architecture in FIG. 4 is similar to architecture in FIG. 2. Additionally, architecture in FIG. 4 supports communications between BMC 204 and target devices 208A-D on multiple communication interfaces 220A-D and communication interfaces 222A-D. As discussed above, communication interfaces 220A-D may be busses that may use I2C and/or MCTP. This architecture may be directed to a scenario when target devices 208A-D have an identical make/model and be connected to HPM 206 using the same I2C device address. In this case, target devices 208A-D may have different respective communication interfaces 222A-D. For example, target device 208A may communicate over communication interface 222A, target device 208B may communicate over communication interface 222B, target device 208C may communicate over communication interface 222C, and target device 208D may communicate over communication interface 222D. Arbiter 216 may assign virtual I2C nodes to target devices 208A-D that use different communication interfaces 222A-D to route the messages from target devices 208A-D over LTPI IP 212. Once arbiter 216 receives the messages from target devices 208A-D over communication interfaces 222A-D, arbiter 216 may use the virtual I2C nodes to pass the messages from HPM 206 to DC-SCM 202 over the same a secondary LTPI I2C channel. On the DC-SCM 202 side, arbiter 214 may assign different communication interfaces 220A-D to messages from different target devices 208A-D. For example, arbiter 214 may assign messages from target device 208A to communication interface 220A, messages from target device 208B to communication interface 220B, messages from target device 208C to communication interface 220C, and messages from target device 208D to communication interface 220D.

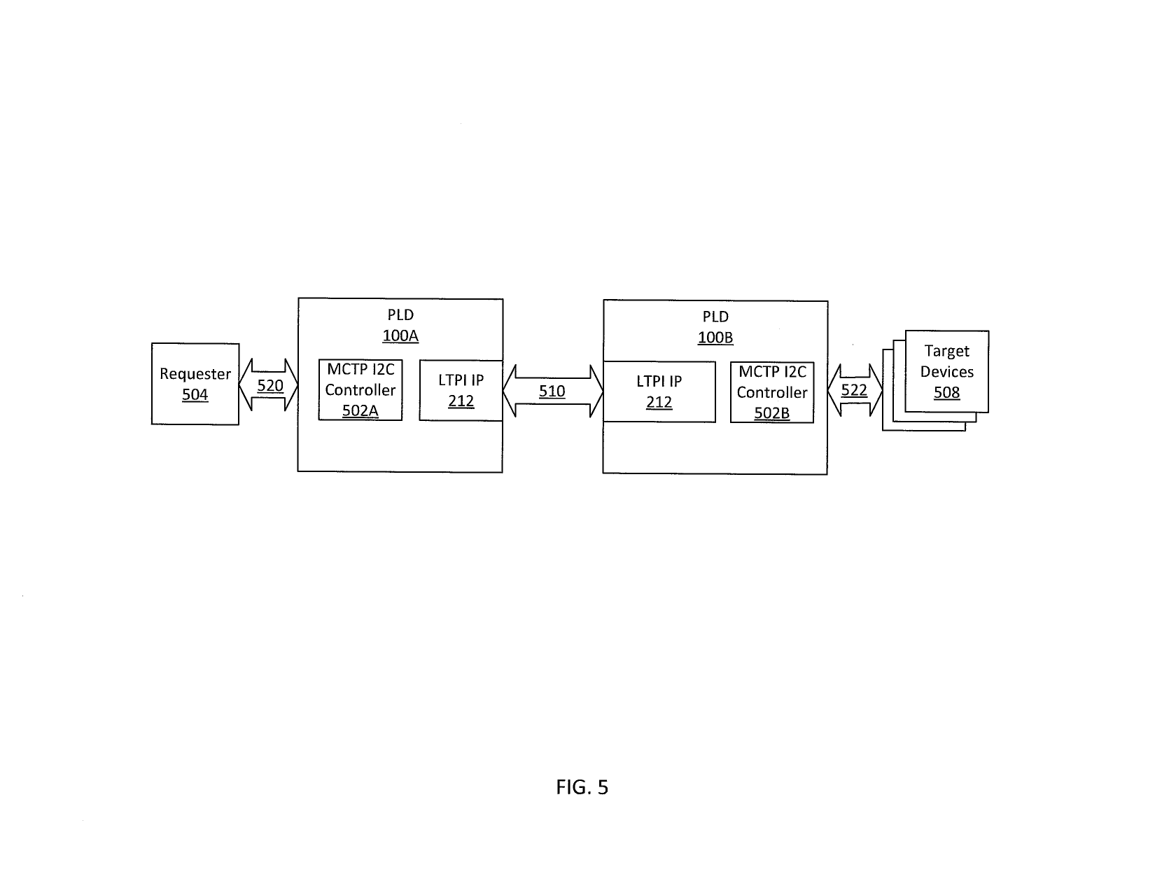

FIG. 5 is a block diagram 500 of another architecture that illustrates a communication interface for device attestation between a requester and target devices, according to some embodiments. FIG. 5 illustrates two PLDs 100A and 100B that communicate using a communication interface 510. Communication interface 510 may operate using multiple modes, such as a one-way communication mode and a two-way communication mode using a primary channel in one direction and a secondary channel in another direction. Communication interface 510 may communicate over I2C using LTPI IP 212, in which case one LTPI I2C channel may be configured as a primary channel that handles egress communications and a second LTPI I2C channel may be configured as a secondary channel which handles ingress communications.

PLD 100A may include an MCTP I2C controller 502A and PLD 100B may include an MCTP I2C controller 502B. MCTP I2C controllers 502A and 502B may configure the one-way communication mode and the two-way communication mode over communication interface 510. For the two-way communication mode, MCTP I2C controllers 502A-B may configure a primary and secondary I2C channels. For example, when requester 504 issues an attestation request, MCTP I2C controller 502A may configure a two-way communication mode and designate an I2C channel from PLD 100A to PLD 100B as a primary channel. MCTP I2C controller 502B may then designate an I2C channel as a secondary channel for communications from PLD 100B to PLD 100A. In this way, requests can be communicated using LTPI IP 212 from PLD 100A to PLD 100B on a primary channel, and responses from PLD 100B to PLD 100A may be communicated on a secondary channel.

In some instances, requester 504 may communicate with PLD 100A over communication interface 520. Communication interface 520 may be an MCTP over I2C. Further, requester 504 may use an SPDM protocol over MCTP to communicate attestation requests to target devices 508. An example attestation request is discussed in FIG. 3.

Target devices 508, may be target devices 208A-D discussed above, and may communicate with PLD 100B using communication interface 522. Communication interface 522 may also use MCTP. Target devices 508 may receive SPDM requests over MCTP and generate SPDM responses over MCTP that are transmitted back to requester 504. In the responses, target devices 508 may specify virtual I2C nodes that may cause MCTP I2C controller 502B to route the responses over the secondary channel in communication interface 510.

The embodiments discussed in FIG. 5 may be incorporated into the architectures discussed in FIGS. 2 and 4. Specifically, PLD 100A and 100B may be incorporated into DC-SCM 292 and HPM 206 in order to initiate an attestation mechanism of target devices 508 with the requester 504, such as BMC 204. Notably, the architecture discussed in FIG. 5 may be applied when PLDs 100A and 100B are incorporated into other types of devices that interconnect LTPI IP in the server platforms.

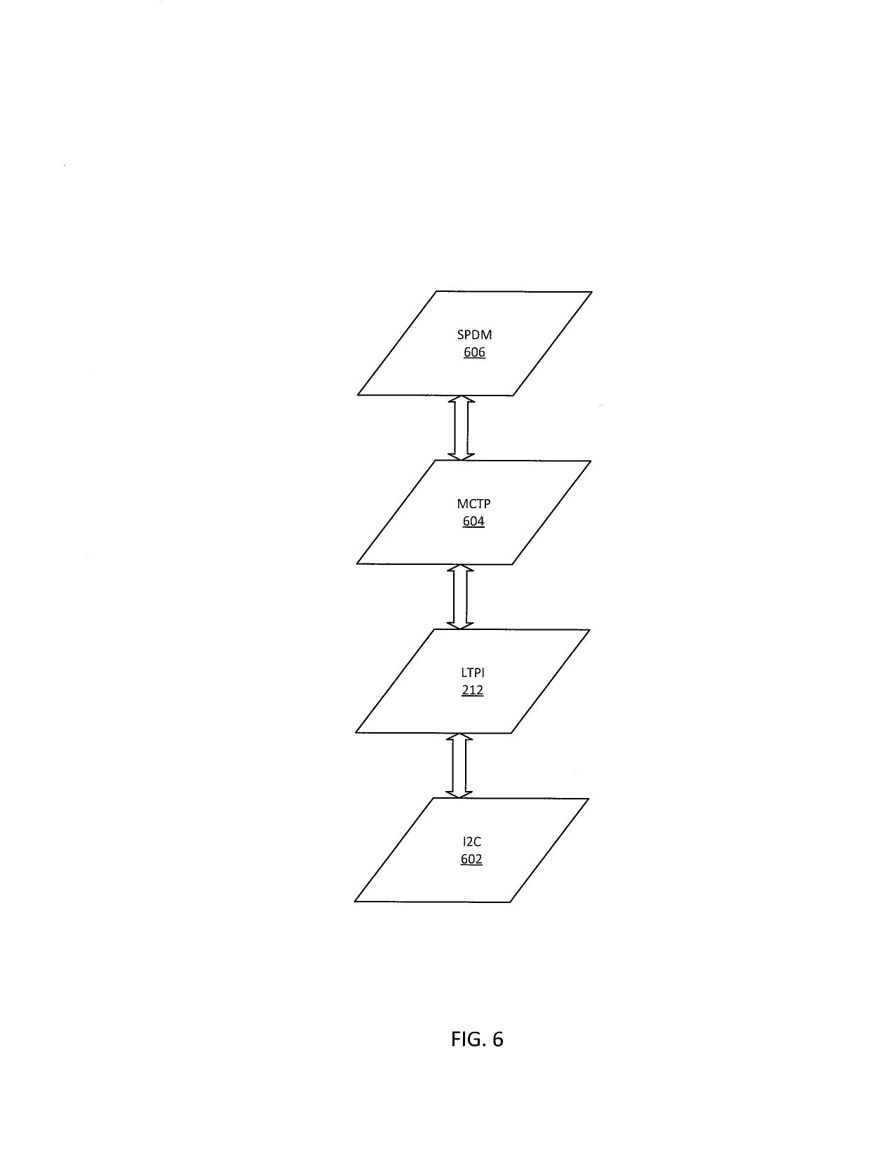

FIG. 6 is a diagram 600 of a software stack for implementing SPDM communications over I2C , according to some embodiments. The software stack may be implemented at BCM 204 or target devices 208. As discussed above, I2C channels may be used for physical communications between PLDs 100, such as PLD 100A and 100B. LTPI IP 212 may use I2C channels to communicate messages. The LTPI IP 212 may include MCTP 604 messages. The body of the MCTP 604 messages may include SPDM 606 requests and responses. BMC 204 and target devices 208 may format information in SPDM 606 requests and responses. Target devices 208 may also use virtual I2C nodes that may be formatted in MCTP 604 packets that are routed by MCTP I2C controllers 502A-B or arbiters 214, 216, for transmission using LTPI IP 212 over I2C channels to BMC 204.

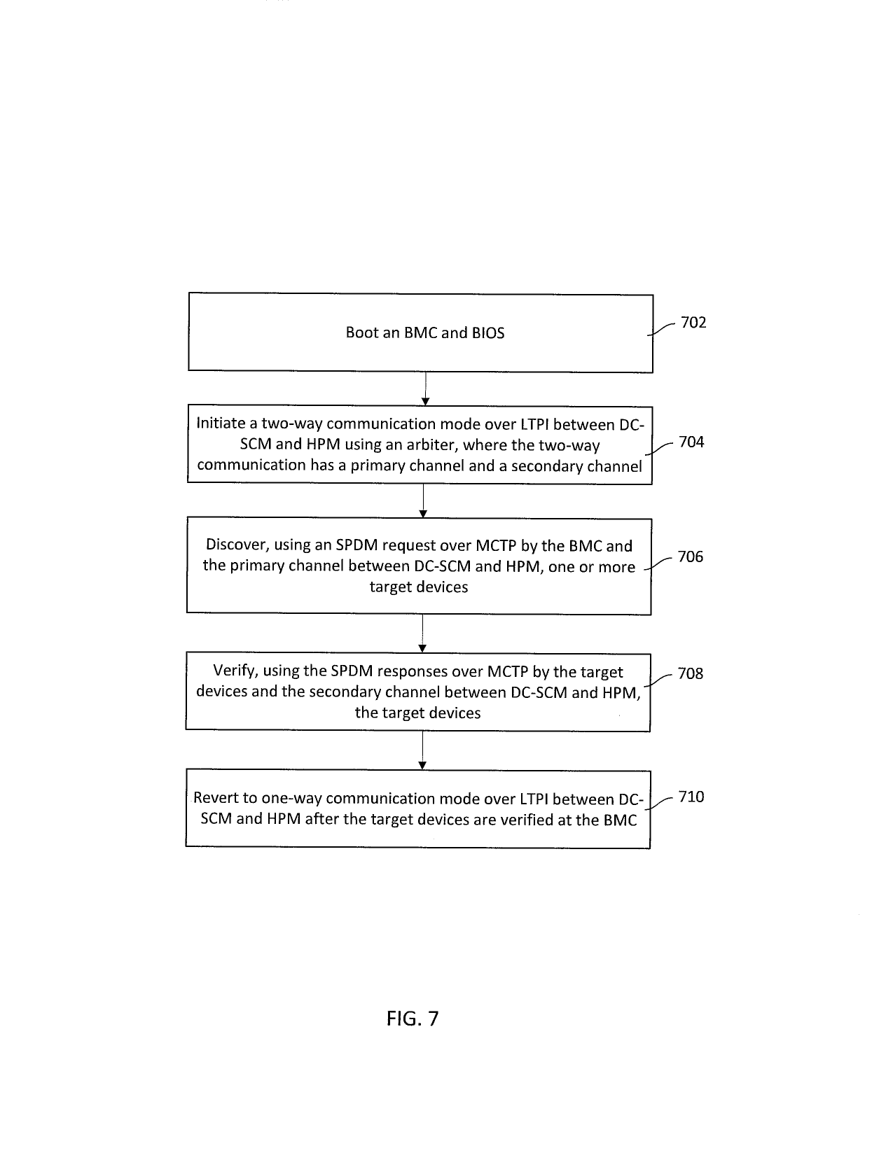

FIG. 7 is a flowchart of an exemplary method 700 of an attestation mechanism, according to some embodiments. Notably, method 700 is exemplary and other methods may also be used. The operations 702-710 in method 700 may be implemented using the hardware circuitry discussed in FIGS. 1-6. Note that one or more of the operations may be deleted, combined, or performed in a different order as appropriate. In method 700, the attestation process is described at a system boot, however, attestation process may occur at any time.

At operation 702, a system boot occurs. For example, BMC 204 and the basic input/output system (BIOS) may boot or start-up.

At operation 704, a two-way communication mode is initiated. For example, arbiter 214 of DC-SCM 202 may initiate a two-way communication mode over LTPI IP 212 between DC-SCM 202 and HPM 206. In the two-way communication mode, arbiters 214, 216 may designate a primary LTPI I2C channel and a secondary LTPI I2C channel.

At operation 706, target devices are discovered. For example, BMC 204 transmits a discovery request over SPDM to discover target devices 208A-D. As discussed above, example devices may be a CPU, a GPU, a NIC, memory devices, power supplies, fans, etc. As discussed above, the discovery request may be made over DC-SCM 202 and HPM 206 using communication interface 220, I/O interface 210, and communication interface 222. In particular, discovery requests may be made using the primary LTPI I2C channel. Further, arbiter 216 may assign virtual I2C nodes to target devices 208A-D and pass the discovery requests to target devices 208A-D via virtual I2C nodes.

At operation 708, target devices are verified using an attestation certificate or another type of verification. For example, each of target devices 208 may transmit a verification response to BMC 204. Verification response may include attestation information, such as an attestation certificate or another type of verification. As discussed above, the verification response may be an SPDM message encapsulated in the body of MCTP, and may be made over HPM 206 and DC-SCM 202 using communication interface 222, I/O interface 210, and communication interface 220. As discussed above, verification responses may include virtual I2C nodes at MCTP level that may cause arbiter 216 to route the verification responses over the secondary LTPI I2C channel. In some embodiments, operations 706 and 708 may be part of the communication mechanism shown in FIG. 3.

At operation 710, a one-way communication mode is initiated. For example, after BMC 204 verifies the target devices 208A-D, arbiters 214, 216, of DC-SCM 202 and HPM 206 may switch PLDs 100 back to a one-way communication mode between DC-SCM 202 and HPM 206. As discussed above, a one-way communication mode is a conventional one direction communication mode over LTPI IP.

Where applicable, various embodiments provided by the present disclosure can be implemented using hardware, software, firmware, or combinations of hardware, software and/or firmware. Also where applicable, the various hardware components and/or software components set forth herein can be combined into composite components comprising software, hardware, and/or both without departing from the spirit of the present disclosure. Where applicable, the various hardware components and/or software components set forth herein can be separated into sub-components comprising software, hardware, or both without departing from the spirit of the present disclosure. In addition, where applicable, it is contemplated that software components can be implemented as hardware components, and vice versa.

Software in accordance with the present disclosure, such as program code and/or data, can be stored on one or more non-transitory machine readable mediums. It is also contemplated that software identified herein can be implemented using one or more general purpose or specific purpose computers and/or computer systems, networked and/or otherwise. Where applicable, the ordering of various steps described herein can be changed, combined into composite steps, and/or separated into sub-steps to provide features described herein.

Embodiments described above illustrate but do not limit the invention. It should also be understood that numerous modifications and variations are possible in accordance with the principles of the present invention. Accordingly, the scope of the invention is defined only by the following claims.

We claim:

1. A system comprising:
a host processing module (HPM) coupled to a plurality of target devices;
a data center secure control module (DC-SCM) comprising a first arbiter and configured to communicate using Low-Voltage Differential Signaling (LVDS) tunneling protocol interface (LTPI IP) with the HPM, and configured to:
receive at least one request from a baseboard management controller (BMC) over a Management Control Transfer Protocol (MCTP), wherein the at least one request requests attestation information from the plurality of target devices;
establish, using the first arbiter, and based on the at least one request, a two-way communication mode over the LTPI IP with the HPM, wherein the two-way communication mode includes a primary channel and a secondary channel;
pass the at least one request to the HPM over the primary channel; and
receive a plurality of responses from the plurality of target devices coupled to the HPM over the secondary channel, wherein the plurality of responses include the attestation information from the plurality of target devices for the BMC.

2. The system of claim 1, further comprising:
the BMC configured to issue the at least one request during a BMC boot process.

3. The system of claim 1, wherein the primary channel is a first LTPI inter-integrated circuit (I2C) channel and the secondary channel is a second LTPI I2C channel.

4. The system of claim 1, wherein the primary channel is a first LTPI improved inter-integrated circuit (I3C) channel and the secondary channel is a second LTPI I3C channel.

5. The system of claim 1, wherein the HPM comprises a second arbiter configured to:
assign a plurality of virtual nodes to the plurality of target devices; and
transmit the plurality of responses from the plurality of target devices over the secondary channel based on the plurality of virtual nodes.

6. The system of claim 1, wherein the first arbiter of the DC-SCM is further configured to switch the LTPI IP to a one-way communication mode over after the plurality of responses are received from the plurality of target devices.

7. The system of claim 1, further comprising:
a first target device and a second target device in the plurality of target devices having a same make and model, wherein the first target device is coupled to the HPM using a first communication interface and the second target device is coupled to the HPM using a second communication interface, and wherein the first communication interface and the second communication interface communicate using the MCTP; and
wherein the HPM comprises a second arbiter coupled to the first communication interface and the second communication interface and configured to:
assign a first virtual node to the first target device and a second virtual node to the second target device;
receive a first response in the plurality of responses from the first target device over the first communication interface and a second response from the plurality of responses over the second communication interface; and
cause, using the first virtual node and the second virtual node, the HPM to transmit the first response and the second response over the secondary channel to the DC-SCM.

8. The system of claim 7, further comprising the BMC coupled to the DC-SCM over a third communication interface and a fourth communication interface, wherein the third communication interface and the fourth communication interface communicate using the MCTP; and
wherein the first arbiter of the DC-SCM is further configured to:
receive the first response and the second response over the secondary channel; and
transmit, to the BMC, the first response over the third communication interface and the second response over the fourth communication interface.

9. The system of claim 1, wherein the at least one request and the plurality of responses are SPDM messages encapsulated within a body of an MCTP packet.

10. A method comprising:
initiating, using a first arbiter at a DC-SCM, a two-way communication mode over two LTPI I2C channels between the DC-SCM and an HPM;
discovering, using a plurality of discovery requests from a BMC transmitted on one of the two LTPI I2C channels between the DC-SCM and HPM, a plurality of target devices coupled to the HPM; and
verifying, using a plurality of responses transmitted from the plurality of target devices over a second of the two LTPI I2C channels between the DC-SCM and the HPM, the plurality of target devices.

11. The method of claim 10, further comprising:
booting up the BMC; and
wherein the initiating the two-way communication mode occurs during the boot up of the BMC.

12. The method of claim 11, further comprising:
switching, using the first arbiter at the DC-SCM, to a one-way communication mode over a plurality of LTPI channels between the DC-SCM and the HPM upon completion of the booting up of the BMC.

13. The method of claim 10, wherein the plurality of discovery requests and the plurality of responses are encapsulated in SPDM messages encapsulated in MCTP packets.

14. The method of claim 10, further comprising:
configuring the two LTPI I2C channels as a primary LTPI I2C channel and a secondary LTPI I2C channel, wherein the plurality of discovery requests are transmitted over the primary LTPI I2C channel and the plurality of responses are transmitted over the secondary LTPI I2C channel.

15. The method of claim 10, further comprising:
generating a virtual I2C node for each target device in the plurality of target devices, wherein the virtual I2C node corresponds to one of the two LTPI I2C channels.

16. The method of claim 10, wherein a first target device and a second target device in the plurality of target devices comprise a same make and model; and
wherein the discovering further comprises:
transmitting a first request in the plurality of discovery requests from the BMC over a first MCTP communication interface;
transmitting a second request in the plurality of discovery requests from the BMC over a second MCTP communication interface; and
transmitting, using the first arbiter at the DC-SCM, the first request and the second request to the first target device and the second target device over the one of the two LTPI I2C channels.

17. A programmable logic device (PLD), comprising:
a first communication interface configured to communicate MCTP packets, wherein the MCTP packets include a request and a response for attestation information;
a second communication interface configured to communicate over LTPI IP; and
an arbiter configured to switch the PLD between a two-way communication mode of operation and a one-way communication mode of operation, wherein the two-way communication mode of operation comprises a primary channel for egress communications over the LTPI IP and a secondary channel for ingress communications over the LTPI IP; and
wherein the MCTP packets are communicated over the first communication interface and the second communication interface using the primary and secondary channel.

18. The PLD of claim 17, wherein the second communication interface is an I2C interface.

19. The PLD of claim 17, wherein the attestation information in the MCTP packets is configured to verify at least one target device connected to the PLD.

20. The PLD of claim 17, wherein the arbiter is further configured to switch to the two-way communication mode of operation in response to receiving an indication over the first communication interface that a device coupled to the PLD is booting up.
